(19) United States
(12) Patent Application Publication
(10) Pub. No.: US 2015/0364860 A1
(43) Pub. Date: Dec. 17, 2015

(54) ELECTRICAL CONNECTOR ASSEMBLY WITH IMPROVED SHELL

(71) Applicant: FOXCONN INTERCONNECT TECHNOLOGY LIMITED, Grand Cayman (KY)

(72) Inventor: YUNG-CHANG CHENG, New Taipei (TW)

(21) Appl. No.: 14/739,200

(22) Filed: Jun. 15, 2015

(30) Foreign Application Priority Data
Jun. 13, 2014 (CN) 201410262723.9

(51) Int. Cl. H01R 13/60

(52) U.S. Cl. CPC H01R 13/60

(57) ABSTRACT

An electrical connector assembly (200) comprises: an adapter connector (10) having a first connector (110), a second connector (120) electrically connected to the first connector, and a first shell (140) enclosing on the second connector and a rear end of the first connector; a plug connector (20) having a third connector (220) for mating with the second connector, a second shell enclosing on a rear end of the third connector, and a cable (230) connected to the third connector and exposed from a rear end of the second shell; a first magnetic member (310) fixed to a side of the first shell; and a second magnetic member (320) fixed to a side of the second shell; wherein the adapter connector is positionable beside the plug connector to enable attraction of the first magnetic member to the second magnetic member.

### BACKGROUND OF THE INVENTION

1. Field of the Invention

The present invention relates to an electrical connector assembly including an adapter connector and a plug connector, and more particularly to an electrical connector assembly having plural magnetic members connected between adapter and plug housings.

2. Description of Related Art

To connect a plug connector to an electronic device generally requires the plug connector to have conforming interface, such as specification and profile, with a socket connector of the electronic device; if the interface does not match, usually an additional adapter connector is needed. The adapter is usually separated from the plug connector when not in use, thus making it easy to get lost.

U.S. Pat. No. 7,473,141 discloses a transfer plug for a variety of sockets, including an adapter connector and a plug connector. The adapter connector includes an insulating shell having a first and a second connectors, and two arms each having one end pivotally connected to the shell. Another end of the arm is pivotally and slidable connected to the plug connector. The signal plug is pivotable relative to the insulating shell in generally up and down directions, in contrast to a horizontal direction, within a limited range.

An electrical connector assembly with an improved shell is desired.

### BRIEF SUMMARY OF THE INVENTION

Accordingly, an object of the present invention is to provide an electrical connector assembly having improved plug connector and adapter connector.

In order to achieve the above-mentioned object, a plug connector of an electrical connector assembly in accordance with the present invention comprises an adapter connector having a first connector, a second connector electrically connected to the first connector, and a first shell enclosing on the second connector and a rear end of the first connector, a plug connector having a third connector for mating with the second connector, a second shell enclosing on a rear end of the third connector, a cable connected to the third connector and exposed from a rear end of the second shell, a first magnetic member fixed to a side of the first shell, and a second magnetic member fixed to a side of the second shell, wherein the adapter connector is positionable beside the plug connector to enable attraction of the first magnetic member to the second magnetic member.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is a perspective view of an electrical connector assembly according to the present invention, in which an adapter connector thereof is assembled with a plug connector thereof;

FIGS. 2-3 is exploded views of the electrical connector assembly shown in FIG. 1; and

FIG. 4 is a perspective view of the electrical connector assembly, in which the adapter connector is mounted beside the plug connector.

### DETAILED DESCRIPTION OF THE PREFERRED EMBODIMENT

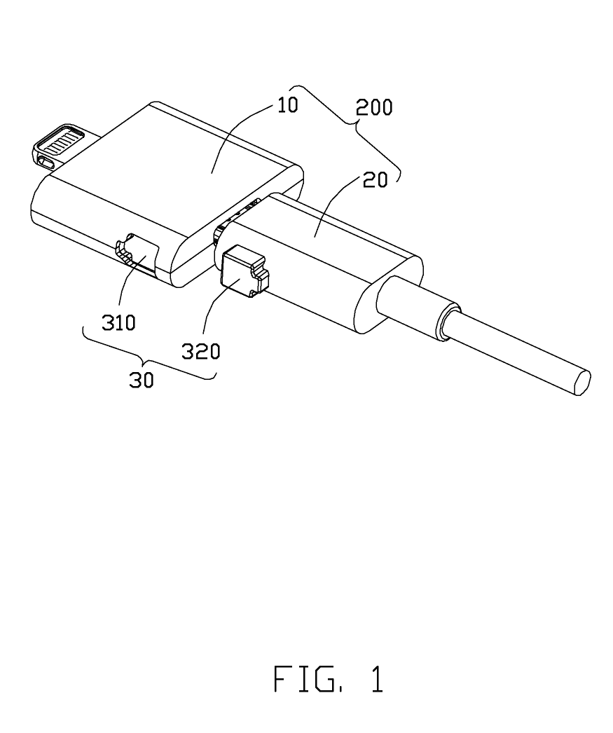

Referring to FIG. 1, an electrical connector assembly 200 in accordance with the present invention comprises a plug connector 20, a adapter connector 10 used in conjunction with the plug connector 20, and a magnetic member assembly 30 assembled between the plug connector 20 and the adapter connector 10.

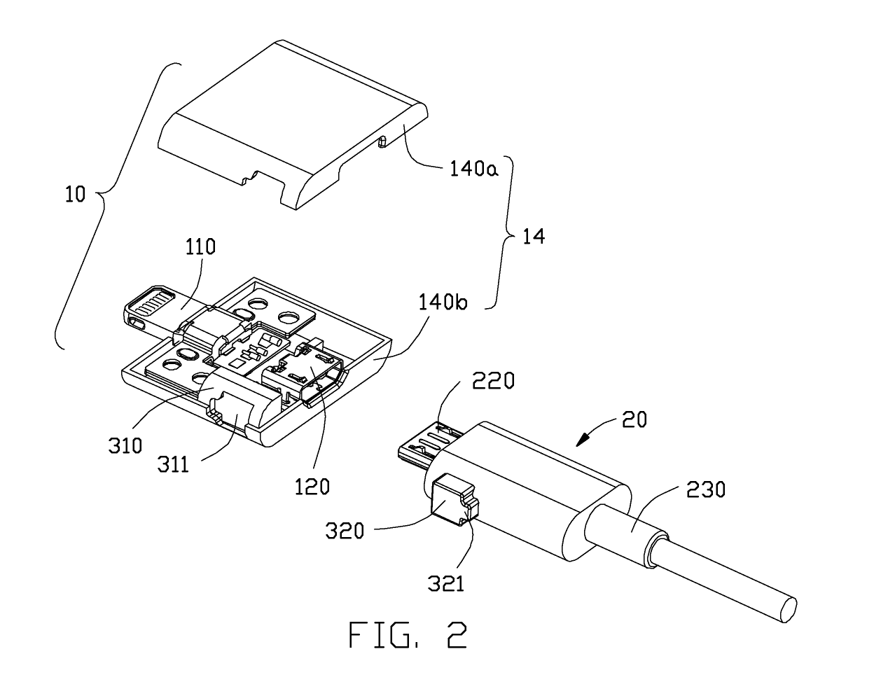

Referring to FIG. 2, the adapter connector 10 comprises a main body 100, a first connector 110 defined on a first end of the main body 100, a second connector 120 eclectically connecting to the first connector 110 and defined on a second end of the main body 110, and a first shell 140. The first connector 110 may be a plug type or male type connector and the second connector 120 may be a receptacle or female type connector.

Referring to FIG. 2, the first shell 140 includes a first portion 140a and a second portion 140b engaged with each other to form a receiving space for receiving the main body 100, the first connector 110, and the second connector 120. A front end of the first connector 110 exposes from the first shell 140.

Referring to FIG. 2, the plug connector 20 includes a second shell 210, a third connector 220 fixed in a front end of the second shell 210 and exposed therefrom, and a cable 230 through a rear end of the second shell 210 and electrically connected to the third connector 220. When the adapter connector 10 is used, the third connector 220 is electrically connected to the second connector 120.

Referring to FIG. 2, the magnetic member assembly 30 includes a first magnetic member 310 and a second magnetic member 320. The first magnetic member 310 and the second magnetic member 320 are fixed to the adapter connector 10 and the plug connector 20 respectively, and at least one of the two can provide magnetic attraction on the other, in other words, the two can be adsorbed and fixed to each other by magnetic attraction. In this embodiment, both of the first magnetic member 310 and the second magnetic member 320 are essentially massive. A groove 311 is defined on a sidewall of the first magnetic member 310. An embedded portion 321 is defined on a sidewall of the second magnetic member 320. The outer contour of the embedded portion 321 is consistent with the inter contour of the groove 311, so that the embedded portion 321 can be engaged with groove 311 in a fitting, snap or docked manner. In this embodiment, two inside walls of the groove 311 are of step-shape respectively and the two inside walls symmetrical to each other. In other embodiment, the contour of the groove 311 can be any shape easy to form and fix, e.g., semi-circular, triangular, etc. The first magnetic member 310 and the second magnetic member 320 can be fixed to the first shell 140 and the second shell 210 respectively by any suitable means. The groove 311 of the first magnetic member 310 and the embedded portion 321 of the second magnetic member 320 are exposed to the outside of the first shell 140 and the second shell 210, so as to make it achievable to engage the embedded portion 321 to the groove 311. In this embodiment, the fixing positions of the first magnetic member 310 and the second magnetic member 320 are not to be limited.

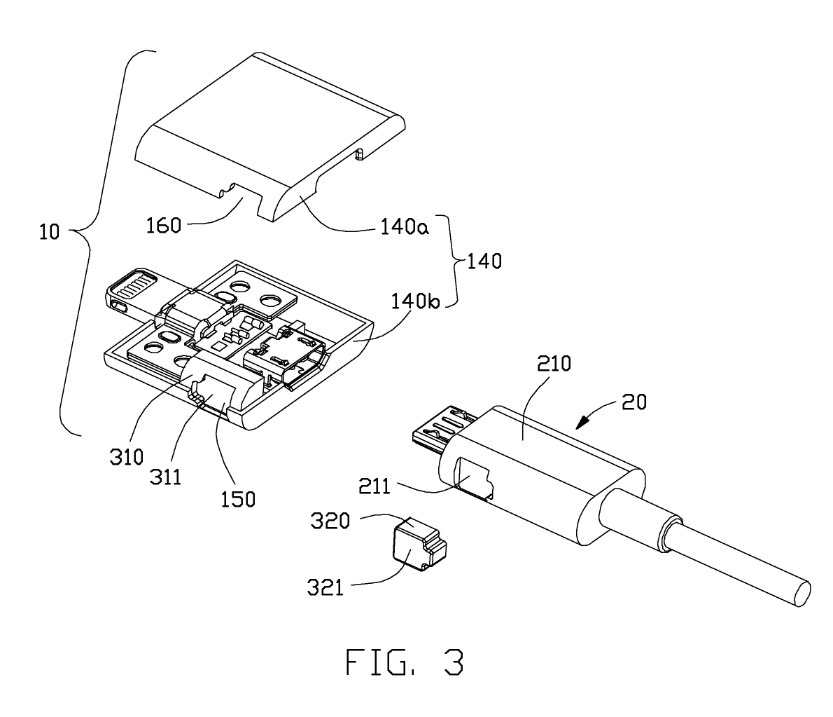

Referring to FIG. 3, in present embodiment, a embedded fixing manner of the magnetic member assembly 30 is described in detail. Two gaps 150,160 whose openings are opposite are respectively defined on the first portion 140a and the second portion 140b, the two gaps 150,160 combine to form a rectangular hole. The first magnetic member 310 is assembled in the first shell 140, and the sidewall which defines the groove 311 of the first magnetic member 310 is against an inside wall of the first shell 140. The groove 311 is completely exposed to the outside of the first shell 140 through the rectangular hole. A built-in groove 211 is defined on the second shell 210 of the plug connector 20, and the second magnetic member 320 is embedded and fixed in the built-in groove 211. In other embodiments, the first magnetic member 310 can be fixed to the plug connector 20, and the second magnetic member 320 can be fixed to the adapter connector 10.

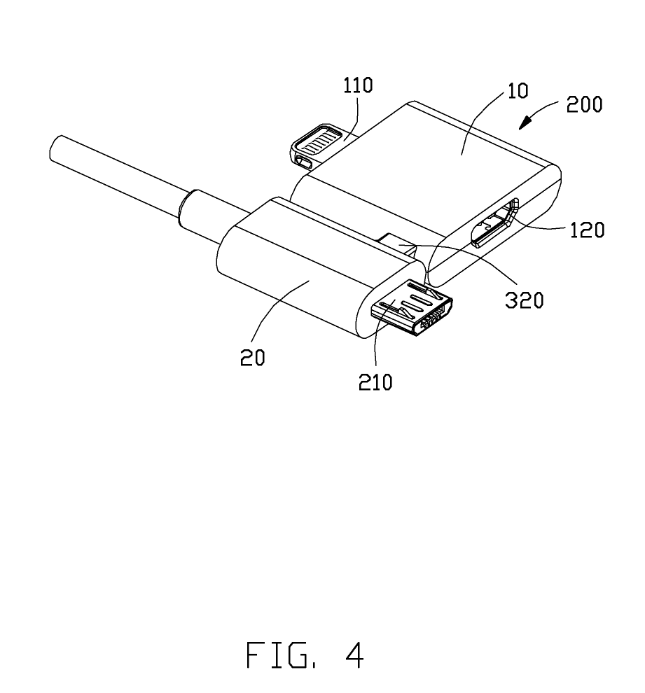

Referring to FIG. 4, without using the adapter connector 10, the adapter connector 10 is disassembled from the plug connector 20, the embedded portion 321 of the second magnetic member 320 is received in the groove 311 of the first magnetic member 310 according to the right position and direction, thus the adapter connector 10 is fixed with the plug connector 10, and easy to carry, to prevent loss.

It is to be understood, however, that even though numerous, characteristics and advantages of the present invention have been set fourth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

What is claimed is:

1. An electrical connector assembly comprising:
an adapter connector having a first connector, a second connector electrically connected to the first connector, and a first shell enclosing on the second connector and a rear end of the first connector;
a plug connector having a third connector for mating with the second connector, a second shell enclosing on a rear end of the third connector, and a cable connected to the third connector and exposed from a rear end of the second shell;
a first magnetic member fixed to a side of the first shell; and
a second magnetic member fixed to a side of the second shell; wherein
the adapter connector is positionable beside the plug connector to enable attraction of the first magnetic member to the second magnetic member.

2. The electrical connector assembly as recited in claim 1, wherein a groove is defined on a sidewall of the first magnetic member, and an embedded portion is defined on the second magnetic member.

3. The electrical connector assembly as recited in claim 2, wherein an outer contour of the embedded portion matches an inner contour of the groove.

4. The electrical connector assembly as recited in claim 1, wherein:
the first shell has a first portion and a second portion engaged with the first portion;
two gaps are defined on the first portion and the second portion respectively to together form a hole; and
the first magnetic member bears against an inside wall of the first shell and exposes to the hole.

5. An electrical connector system comprising:
an adaptor including first and second connectors respectively disposed at two opposite ends thereof in the front-to-back direction;
a plug cable connector including a third connector and a cable respectively disposed at two opposite ends thereof in said front-to-back direction, said third connector being able to mate with the second connector so as to have the plug cable connector and the adaptor assembled together along the front-to-back direction;
a first magnetic attraction element disposed upon a lateral side of the adaptor;
a second magnetic attraction element disposed upon another lateral side of the plug cable connector; wherein
the adaptor and the plug cable connector are adapted to be assembled with each other in a side-by-side manner via coupling between the first magnetic attraction element and the second attraction element.

6. The electrical connector system as claimed in claim 5, wherein when the adaptor and the plug cable connector are assembled in the side-by-side manner, the second connector an the third connector are essentially neighbored with each other in a transverse direction perpendicular to said front-to-back direction.

7. The electrical connector system as claimed in claim 5, wherein at least one of said first magnetic attraction element and said second magnetic attraction element is a magnet.

8. The electrical connector system as claimed in claim 5, wherein one of said first magnetic attraction element and said second magnetic attraction element protrudes laterally and the other is recessed laterally so as to have said one extend into the other to assure no relative movement between the adaptor and the plug cable connector along the front-to-back direction once the adaptor and the plug cable connector are assembled side by side.

9. The electrical connector system as claimed in claim 5, wherein the first magnetic attraction element is located closer to the second connector that to the first connector, and the second magnetic attraction element is located closer to the third connector than to the cable.

10. The electrical connector system as claimed in claim 5, wherein said first connector and said third connector protrudes forwardly while the second connector is recessed.
